(19) United States
(12) Patent Application Publication
(10) Pub. No.: US 2005/0058933 A1
(43) Pub. Date: Mar. 17, 2005

(54) Quantum efficient photoacid generators for photolithographic processes

(76) Inventors: Robert P. Meagley, Hillsboro, OR (US); Ernisse S. Putna, Beaverton, OR (US)

Correspondence Address: TROP PRUNER & HU, PC, 8554 KATY FREEWAY, SUITE 100, HOUSTON, TX, 77024, US

(21) Appl. No.: 10/666,019

(22) Filed: Sep. 17, 2003

(51) Int. Cl. G03C 1/76

(52) U.S. Cl. 430/270.1

(57) ABSTRACT

A photoacid generator with sigma-bonded cations may be utilized with certain photolithographic processes to provide desirable absorbance and high quantum efficiency.

### BACKGROUND

This invention relates to making semiconductors and, particularly, to photolithography.

In photolithographic processes, a photoresist is deposited. The photoresist is exposed to radiation via a mask. Some regions of the photoresist develop away and other regions remain.

In order for the photoresist to be most effective, especially in connection with advanced lithographic processes, it should be highly transparent. For example, in connection with 157 nanometer and extreme ultraviolet lithography, the photoresist may absorb too much of the incident radiation. While those photoresists were fully effective for prior generations of lithographic technology, with more modern lithographic techniques, these photoresists may be deficient with respect to their transparency. In particular, the existing photoresists may be too radiation absorptive, which degrades the patterning performance of the resist.

Conventionally, the photoresists have photoacid generators which, upon exposure to radiation, generate acids that implement the breakdown of the photoresist where exposed. Current photoacid generators are not optimized for changes in polymer resins that are implemented to improve transparency. As a result, phase separation may occur due to structural differences.

Thus, there is a need for alternate, transparent photoresists.

### BRIEF DESCRIPTION OF THE DRAWINGS

FIG. 1 is a depiction of a cation in accordance with one embodiment of the present invention;

FIG. 2 is a depiction of a cation in accordance with one embodiment of the present invention; and

FIG. 3 is a depiction of a cation in accordance with one embodiment of the present invention.

### DETAILED DESCRIPTION

Photoacid generator compounds may exhibit improved transparency in comparison to materials currently being used in 157 nanometer and other lithographic technologies. These compounds may maintain sufficient quantum yield under irradiation for chemically amplified photoresists. The photoacid generators may also have improved compatibility with the resin matrix making up a photoresist, in some embodiments.

The photoacid generators may include anions and cations. The cations may have single or sigma bonds using orbital overlap, rather than conventional pi or double bonded species. These sigma-bonded species may enable absorbent moieties to trigger photochemical reaction mechanisms that produce acid upon irradiation of the catalyst precursor by vacuum ultraviolet and ionized radiation, such as, for example, electron beam, ion beam, and extreme ultraviolet lithography processes. The absorbent sigma-bonded moieties may be linked to catalyst precursors as triggers for catalyst formation. Absorption of 157 nanometer electromagnetic radiation, triggering catalyst formation, from a catalyst precursor with sigma-bonded moieties, may be less than with conventional technologies.

The use of absorbing moieties that have reduced absorption at longer wavelengths enable photogenerated catalyst design that may be optimized to 157 nanometer lithography with chemically amplified photoresist in some embodiments. Moieties of the form C—R and C—X, where R may be a hydrogen, an alkyl, a substituted alkyl, and X may be a halogen, a chalcogen or other heteroatoms may be used as catalyst precursors for chemically amplified photoresist for 157 nanometer radiation may be applied. While the fundamental deprotection mechanism common to chemically amplified photoresists may remain unchanged in some embodiments, the classical mechanism may occur without a decrease in overall resist transparency that is typically encountered by the present state of the art photoacid generators.

Currently, many of those skilled in the art have focused primarily on developing polymer resins with very low transparencies in order to facilitate resist patterning for 157 nanometer technologies. While this focus on developing low transparency resin has been a key enabler of the technology thus far, those skilled in the art are still primarily using photoacid generator materials optimized for longer wavelengths developed in earlier technologies, such as phenyl-based materials.

While phenyl-based materials do have good quantum efficiencies, these materials are highly absorbing at 157 nanometer and thus, are not fully optimized for applications at 157 nanometers. The sigma-bonded species are both highly transparent and have sufficient quantum yields at wavelengths of interest to further reduce the overall absorbance of the resist, thereby improving patterning performance. Additionally, due to structural similarities, the sigma-bonded photoacid generators also may be more compatible with polymer resin than conventional classes of photoacid generators.

In particular, the cation portion of the photoacid generator, which is the photon harvesting part, may be modified so that it is sigma-bonded. The highly conjugated phenyl groups typically involved in conventional techniques are replaced by moieties primarily comprising C—H and C—F single bonds. The reduced conjugation reduces the absorption, especially at 157 nanometers, and thereby improves the overall performance of the resist due to lower absorption. At the same time, photoacid generators that are sigma-bonded still exhibit sufficient quantum efficiency to be viable in photoresists through absorption of radiation coupled to bond scission.

Photoacid generators perform two coupled processes. First, radiation is absorbed by a competent moiety whose orbital energy is mated to photons. For longer wavelengths this has been accomplished through the application of pi-bonded species in conjugation. Such antenna moieties are efficient absorbers at longer wavelengths.

In the second process, photoacid generators fragment and form acid after radiation is absorbed. Thus, the energy from the radiation is coupled to bond breaking processes. At longer wavelengths, the efficiency of absorption is relatively low, necessitating multiple absorbing moieties on the photoacid generator. For example, triphenylsulfonium nonaflate has three radiation absorbing phenyl groups. The energy for bond breaking reactions is facilitated from efficient collection of radiation.

At shorter ultraviolet wavelengths of 248 to 193 to 157 nanometers, the efficiency of radiation absorption by molecular species improves, because the radiation is more energetic and capable of exciting more different kinds of chemical bonds. Indeed, few bonds do not absorb at 157 nanometers, complicating resist design.

At 157 nanometers, photoacid generator efficiency is not limited by absorbance, as the photoacid generator molecules are highly absorbing. The high absorption, while not materially improving quantum efficiency, does increase absorption significantly.

The conjugated moieties, such as phenyl groups, may be reduced or eliminated from the cation with the concomitant introduction of more transparent sigma-bonded moieties, such as substituted alkyl groups. The use of sigma-bonded moieties results in photoacid generators that still absorb in proximity to the site of bond scission, allowing coupling of absorption and fragmentation.

As an example, instead of using a conventional cation, the addition of a methyl iodide to a stirred solution of diisopropylsulfide in toluene, heated below reflux, may result in sigma-bond formation. Crystalline diisopropylmethylsulfonium iodide is isolated by evaporation and purified by recrystallization. Photoacid generator formation is accomplished by an ion exchange from the silver nonaflate. Ion exchange to make nonaflate sulfonium salt from sulfonium halide may result in the formation of a sulfonium halide and may follow procedures known in the art.

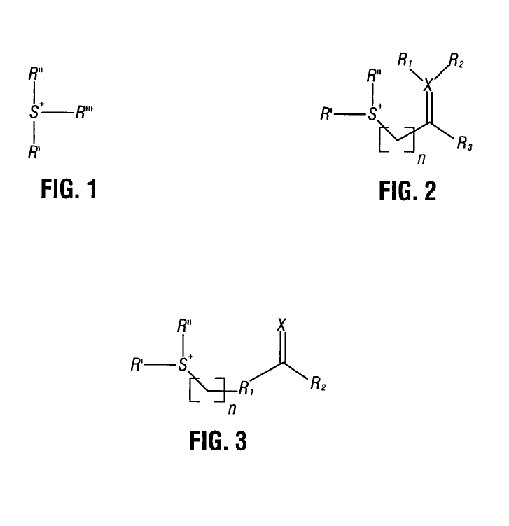

Referring to FIG. 1, an exemplary cation is illustrated that uses a base atom, such as a sulfur atom, coupled to three moieties indicated as R′, R″, and R′″. In this embodiment, each moiety R is coupled by a single bond to the base atom. The moieties R may comprise an alkyl or substituted alkyl (halogen, ethers, esters, carbonates, ketones, or other functionally consistent moieties) to mention two examples. In the embodiment illustrated in FIG. 1, all of the moieties coupled to the base atom are single bonded and, in some embodiments, all of the bonds within each of the moieties R may be single bonded.

Referring to FIG. 2, the base atom, such as a sulfur atom, may be coupled to the moieties R′ and R″, as in FIG. 1. In this case, the moiety R′″ is replaced by a chain of length n coupled through a double bond to a moiety X, in turn coupled to moieties R₁ and R₂. The chain may also be coupled to a moiety R₃. Each of the moieties R₁, R₂, and R₃ may be any of the alkyl or substituted alkyl, for example. Morphology may be rings, chains, or branched structures, to mention a few examples. The element X may be carbon, nitrogen, sulfur, or phosphorus. The chain, indicated as n, may be any length. Thus, in this example, the number of double bonds may be reduced, but some double bonds may still be present. The number of double bonds is reduced to improve transparency compared to that of phenyl-based, conventional cations.

Referring to FIG. 3, in this case, the base atom (i.e., sulfur) is coupled to the moieties R′ and R″ as before. The base atom is also coupled through a chain of length n to a moiety R₁, in turn coupled to a double bond, coupled to X. The double bond may also be coupled to the moiety R₂. In this case, the moieties R₁ and R₂ may include oxygen and some other elements. X, R₁, and R₂ may be carbon, nitrogen, sulfur, or phosphorus. The chain n may be of any length. Again, the number of double bonds coupled to the base atom are reduced, but some double bonding is still permitted. Advantageously, the double bonding is reduced sufficiently to improve transparency over that of conventional phenyl-based cations.

While the use of single bonded systems, rather than double bonded or aryl systems is suggested in accordance with one embodiment of the present invention to ensure adequate quantum efficiency while decreasing the overall absorbance, it is also anticipated that modification of the anion portion of the photoacid generator may also be implemented. For example, the use of a more weakly coordinating, non-basic ion to form a stronger conjugate Bronsted acid is one example of a modified anion portion. In another example, the loading or concentration of the photoacid generator may be modified in the photoresist system to further improve quantum yields versus aryl systems. The anion modification and the concentration modification would not detrimentally affect resist performance from issues such as defects or solubility.

Additionally, while the focus of one embodiment of the present invention is not specifically on the anion portion of the photoacid generator, the new classic cations described herein is considered compatible, not only with perfluoroalkyl sulfonate (PFAS) or perfluorooctyl sulfonate (PFOS) anions, but also with new, more novel anions which are considered more environmentally friendly, such as imide and methide systems recently disclosed. See Lamanna et al., “New Ionic Photo-Acid Generators (PAGs) Incorporating Novel Purfluorinated Anions,” Proceedings of SPIE Vol. 4690 (2002).

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A photoresist comprising:
a photoacid generator that includes a cation with a base atom coupled to at least two sigma-bonded moieties.

2. The photoresist of claim 1 including an anion and a cation, wherein said cation does not include phenyl.

3. The photoresist of claim 1 wherein said photoacid generator includes a cation that is entirely sigma-bonded.

4. The photoresist of claim 1 wherein said photoacid generator includes a cation with a base atom coupled to at least one sigma-bonded moiety.

5. The photoresist of claim 1 wherein said photoacid generator is more transparent than phenyl containing photoacid generators.

6. The photoresist of claim 1 wherein said photoacid generator includes a cation with a first moiety sigma-bonded to a base atom and a chain coupled to said base atom, said chain in turn coupled by a double bond to second moiety.

7. The photoresist of claim 6 wherein said second moiety is selected from the group of carbon, nitrogen, sulfur, and phosphorus.

8. The photoresist of claim 0.7 wherein said second moiety is coupled to an alkyl or a substituted alkyl.

9. The photoresist of claim 8 wherein said alkyl or substituted alkyl includes a halogen, ether, ester, carbonate, or ketone.

10. The photoresist of claim 1 including a photoacid generator including a cation including a base atom coupled to at least two moieties by sigma-bonds, said base atom coupled to a chain in turn coupled to a first moiety, said first moiety coupled through a double bond to a second moiety.

11. The photoresist of claim 10 wherein said second moiety and said first moiety are selected from the group including carbon, nitrogen, sulfur, and phosphorus.

12. The photoresist of claim 11 wherein at least one of said first and second moieties includes oxygen.

13. The photoresist of claim 10 wherein said base atom is sulfur.

14. A method comprising:
forming a photoresist with a photoacid generator with a cation having a base atom coupled to at least two sigma-bonded moieties.

15. The method of claim 14 including providing a cation to said photoacid generator that does not include phenyl.

16. The method of claim 14 including providing an entirely sigma-bonded cation.

17. The method of claim 14 including forming said photoacid generator of a cation with a base atom coupled to at least one sigma-bonded moiety.

18. The method of claim 14 including forming a photoresist with a photoacid generator that is more transparent than phenyl containing photoacid generators.

19. The method of claim 14 including forming said photoacid generator with a cation having a first moiety sigma-bonded to a base atom and a chain coupled to said base atom, coupling said chain by a double bond to a second moiety.

20. The method of claim 19 including forming said second moiety from carbon, nitrogen, sulfur, or phosphorus.

21. The method of claim 20 including forming said second moiety of an alkyl or substituted alkyl.

22. The method of claim 14 including forming the photoacid generator with a cation having a base atom coupled to at least two moieties by sigma-bonds, said base atom coupled to a chain in turn coupled to a first moiety, said first moiety coupled through a double bond to a second moiety.

23. A photoresist comprising:
a photoacid generator including a cation that is entirely sigma-bonded.

24. The photoresist of claim 23 wherein said cation includes a base atom coupled by sigma-bonds to at least three moieties.

25. The photoresist of claim 23 wherein said moieties are alkyl or substituted alkyls.

26. The photoresist of claim 25 wherein said alkyl or substituted alkyl includes a halogen, ether, ester, carbonate, or ketone.

27. The photoresist of claim 23 wherein said photoacid generator includes a sulfur atom sigma-bonded to alkyl groups.

28. The photoresist of claim 24 wherein said base atom is sulfur.
